(19) United States
(12) Patent Application Publication
(10) Pub. No.: US 2007/0236467 A1
(43) Pub. Date: Oct. 11, 2007

(54) Point-of-service device

(76) Inventors: Graham Marshall, Shoreham, NY (US); Ian Jenkins, Stony Brook, NY (US)

Correspondence Address: FAY KAPLUN & MARCIN, LLP, 15O BROADWAY, SUITE 702, NEW YORK, NY, 10038, US

(21) Appl. No.: 11/393,620

(22) Filed: Mar. 30, 2006

(51) Int. Cl. G06F 3/041

(52) U.S. Cl. 345/173

(57) ABSTRACT

Described is a Point-of-Service device comprising a touch screen having an input receiving area, a stylus and a mounting arrangement receiving the stylus. When the stylus is received in the mounting arrangement, the stylus at least partially covers the input receiving area of the touch screen.

### FIELD OF THE INVENTION

The present invention relates generally to point-of-service devices.

### BACKGROUND

In a retail store, a customer may use a point-of-service/sale (POS) device to complete a transaction. Generally, the customer swipes a credit/debit card through a magnetic strip reader on the POS device to initiate payment. Using a pointed object (e.g., a stylus provided with the POS device), the customer responds to a series of queries presented on a touch screen of the POS device to complete the transaction. The customer may also be required to trace a signature on the touch screen. The stylus is typically tethered to the POS device to prevent loss and utilizes a rounded tip to prevent damage to the touch screen. When the customer uses an object other than the stylus (e.g., a pen, a pencil, a fingernail, a finger, etc.), the touch screen may be damaged, and the POS device must be repaired or replaced.

### SUMMARY OF THE INVENTION

The present invention relates to a Point-of-Service device. The Point-of-Service device comprises a touch screen having an input receiving area, a stylus and a mounting arrangement receiving the stylus. When the stylus is received in the mounting arrangement, the stylus at least partially covers the input receiving area of the touch screen.

### DESCRIPTION OF THE DRAWINGS

FIG. 1 shows an exemplary embodiment of a Point-of-Service device according to the present invention.

FIG. 2 shows an exemplary embodiment of a mounting arrangement according to the present invention.

FIG. 3 shows an exemplary embodiment of a method for completing a transaction using a Point-of-Service device according to the present invention.

### DETAILED DESCRIPTION

The present invention may be further understood with reference to the following description and the appended drawings, wherein like elements are referred to with the same reference numerals. The present invention describes a Point-of-Service/Sale (POS) device. While the exemplary embodiments of the present invention will be described with reference to the POS device, those of skill in the art will understand that the present invention may be utilized by any device which uses a stylus to enter input to the device.

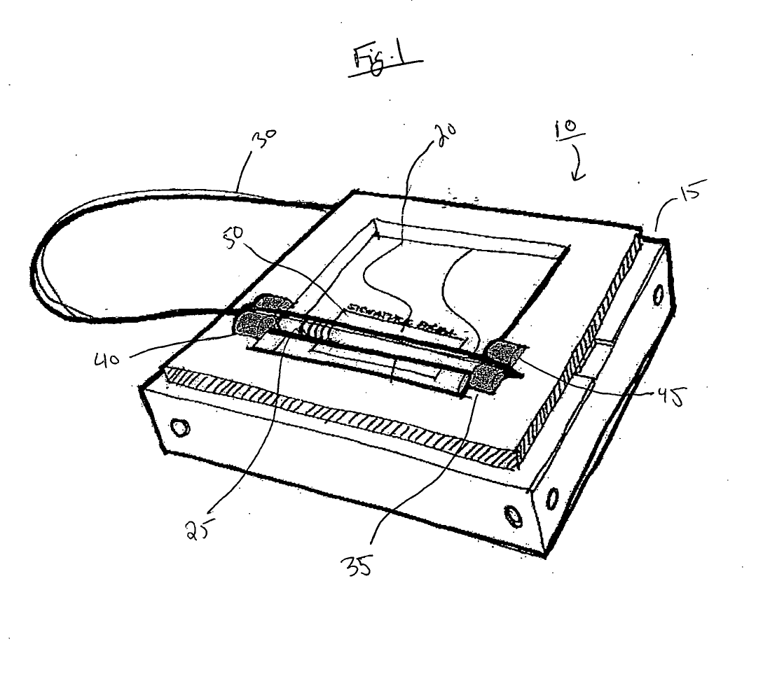

FIG. 1 shows an exemplary embodiment of a POS device 10 according to the present invention. In the exemplary embodiment, the POS device 10 is used at a checkout counter in a retail store for completing customer transactions. However, in other embodiments, the POS device 10 may be a hand-held device, e.g., a PDA, a tablet, an imager-/laser-based scanner, etc. which is configured for personal and/or industrial use. For example, a delivery person may use the POS device 10 to confirm delivery of a parcel, an individual may utilize the POS device 10 for e-commerce, etc.

The POS device 10 includes a housing 15 which encapsulates and protects internal circuitry (e.g., processor, memory, etc.) of the POS device 10. The housing 15 may include mounting components for positioning the POS device 10 at the checkout counter. For example, the POS device 15 may be positioned on a swiveling and/or tiltable base resting on the checkout counter. Alternatively, the housing 15 may be affixed to a stand which extends upward from the checkout counter. In this embodiment, a customer may interface with the POS device 15 without having to lean over. This may also be advantageous in that the customer may not apply as much pressure to the POS device 15 as compared to when the POS device 15 rests on the checkout counter. A reduction of the amount of pressure applied to the POS device 15 reduces damage to components thereof, as will be described further below.

A touch screen 20 is disposed on the housing 15 and presented to the customer for receiving input and displaying output during the transaction. The touch screen 20 may be a conventional display screen which sends data (e.g., coordinates) to the processor of the POS device 10 corresponding to a location which was touched. The processor utilizes the coordinates from the touch screen 20 along with knowledge of content being displayed to execute corresponding actions. For example, during the customer transaction, the touch screen 20 may present a formatted display of a plurality of choices (e.g., input receiving areas) to the customer regarding payment-type options, e.g., Credit Card, Debit Card, Gift Card, etc. The customer touches the touch screen 20 at the location corresponding to a selected payment-type (e.g., Credit Card), and the processor uses knowledge of the formatted display and coordinates of the touch on the touch screen 20 to determine that the customer intends to pay with a credit card. During the customer transaction, the POS device 10 may present various content on the touch screen 20 including, but not limited to, product/parcel descriptions, customer information, advertisements, etc.

In the exemplary embodiments, a stylus 25 is provided for use with the touch screen 20. The stylus 25 is generally an elongate, pen-shaped instrument which includes a rounded tip for interfacing with the touch screen 20. As known by those of skill in the art, the rounded tip prevents damage to the touch screen 20 which would otherwise occur when using a pointed tip. As shown in FIG. 1, the stylus 25 is coupled to the housing 15 by a tether 30, which may prevent loss of the stylus 25 or the customer accidentally taking the stylus 25 after the transaction is complete.

The stylus 25 may be used to navigate through the content presented on the touch screen 20 and enter input to the POS device 10. For example, after the customer indicates the payment type, the touch screen 20 may display an amount of the transaction and prompt the customer to agree to have the credit card charged with the amount. When the customer touches the touch screen 20 at Yes, the customer is prompted to provide a signature to complete the charge to the credit card. The signature may then be traced on the touch screen 20, as described further below.

The stylus 25 is detachably coupled to the POS device 10 by a mounting arrangement 35 positioned on the housing 15. In the exemplary embodiment, the mounting arrangement 35 includes a first stylus holder 40 for holding a base portion of the stylus 25 and a second stylus holder 45 for holding a tip portion of the stylus 25. Those of skill in the art will understand that alternative embodiments of the mounting arrangement 35 may include only a single stylus holder or more than two stylus holders. As shown in FIG. 1, the first and second stylus holders 40,45 may be disposed on opposite sides of the touch screen 20 and aligned on a same latitudinal axis. Thus, when the stylus 25 is in a mounting position (e.g., received by the mounting arrangement 35), the stylus 25 covers a portion of the touch screen 20. As will be described further below, when in the mounting position, the stylus 25 may cover a signature line portion 50 of the touch screen 20, preventing the customer from inputting the signature until the stylus 25 is removed from the mounting arrangement 35.

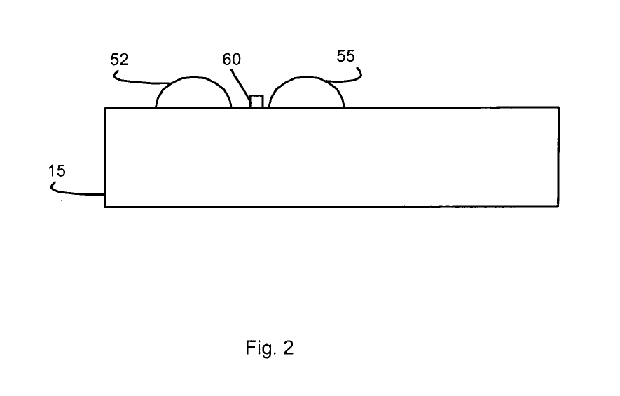

FIG. 2 shows an exemplary embodiment of the first stylus holder 40 for the mounting arrangement 35 according to the present invention. Those of skill in the art will understand that the first stylus holder 40 may be substantially identical to the second stylus holder 45 such that all description of the first stylus holder 40 may similarly apply to the second stylus holder 45. In the exemplary embodiment, the first stylus holder 40 comprises first and second compressive members 52,55 which frictionally retain the stylus 25 therebetween. Those of skill in the art will understand that the first and/or second stylus holders 40, 45 may utilize any mechanism for detachably receiving the stylus 25 including, but not limited to, hooks, clasps, a rack, adhesives, Velcro®, magnets, etc.

The first stylus holder 40 may further include a switch 60 which provides data to the processor of the POS device 10 indicating whether the stylus 25 is received in the first stylus holder 40. As shown in FIG. 2, the switch 60 may be a depressible button which moves between depressed and non-depressed states and is biased in the non-depressed state. When the stylus 25 is received in the first stylus holder 40, the stylus 25 forces the switch 60 into the depressed state which indicates, to the processor, that the stylus 25 is received by the mounting arrangement 35. When the stylus 25 is removed from the first stylus holder 40, the switch 60 returns to the non-depressed state which indicates that the stylus 25 is not received in the mounting arrangement 35. Those of skill in the art will understand that the switch 60 may be any mechanism, e.g., mechanical switch, electrical contact, electrical/mechanical/optical sensor, etc., for providing feedback to the POS device 10 indicative of whether the stylus 25 is in the mounting position. As will be described further below, the switch 60 may also be used to navigate through content provided on the touch screen 20.

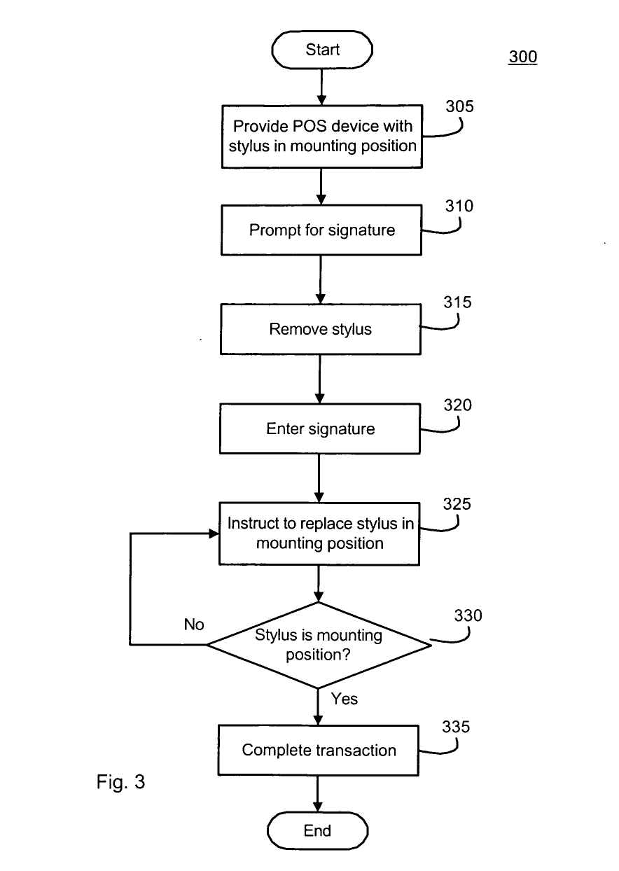

FIG. 3 shows an exemplary embodiment of a method 300 for completing a transaction using the POS device 10 according to the present invention. Prior to implementation of the method, the customer may have tendered payment (credit card, cash, etc.), or a recipient may have been presented with the parcel. Although the method will be described with reference to the customer transaction, those of skill in the art will understand that the method 300 similarly applies to other uses of the POS device 10 mentioned herein and/or known to those of ordinary skill in the art.

In step 305, the POS device 10 is provided to the customer with the stylus 25 in the mounting position, i.e., received in the mounting arrangement 35. In the mounting position, the stylus 25 forces the switch 60 into the depressed state. Thus, the POS device 10 detects the presence of the stylus 25.

In step 310, the customer is prompted to enter a signature on the touch screen 20. In the exemplary embodiment, the touch screen 20 presents the signature line portion 50 to the customer. However, as described above, the signature line portion 50 may be substantially aligned with the latitudinal axis of the mounting arrangement 35. Thus, when the signature line portion 50 is presented on the touch screen 20 and the stylus 25 is in the mounting position, the signature line portion 50 may be covered by the stylus 25. To enter the signature, the customer must remove the stylus 25 from the mounting arrangement 35.

In step 315, the stylus 25 is removed from the mounting arrangement 35. The POS device 10 detects the removal of the stylus 25, because the switch 60 returns to the non-depressed state. Removal of the stylus 25 uncovers the signature line portion 50 on the touch screen 20, allowing the customer to enter the signature.

In step 320, the customer enters (e.g., traces) the signature on the touch screen 20 using the stylus 25. In step 325, the POS device 10 instructs the customer to replace the stylus 25 in the mounting position to complete the transaction. Those of skill in the art will understand that any prompts, instructions and/or commands described as being presented on the touch screen 20 may alternatively be issued by an employee in the transaction. That is, a cashier may instruct the customer to replace the stylus 25 on the POS device 10 to complete the transaction.

In step 330, the POS device 10 determines whether the stylus 25 has been returned to the mounting position based on, for example, the state of the switch 60. When the stylus 25 is returned to the mounting position, the switch 60 in the first stylus holder 40 is forced back into the depressed state, and the transaction is completed (or may proceed to a next step), as shown in step 335. If the POS device 10 does not detect that the stylus 25 has been returned to the mounting position, it may again instruct the user to do so, as in step 325. Alternatively, the POS device 10 may time the transaction out if the stylus 25 is not returned to the mounting position in a predetermined time.

The exemplary embodiments of the present invention may prevent loss of the stylus 25 and damage to the touch screen 20. The mounting arrangement 35, along with the tether 30, and the detectable states of the switch 60 may ensure that the stylus 25 will not be lost. As such, the customer (or recipient or individual user) may not be prompted to use a non-stylus object, e.g., a pen, pencil, fingernail, finger, etc., to enter input to the touch screen 20.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a touch screen having an input receiving area;
a stylus; and
a mounting arrangement receiving the stylus,
wherein, when the stylus is received in the mounting arrangement, the stylus at least partially covers the input receiving area of the touch screen.

2. The device according to claim 1, wherein the device is one of a Point-of-Service device, a PDA, a tablet, an imager-based scanner and a laser-based scanner.

3. The device according to claim 1, wherein the input receiving area is a signature line.

4. The device according to claim 1, wherein the mounting arrangement includes first and second stylus holders positioned on opposite sides of the touch screen.

5. The device according to claim 4, wherein the first and second stylus holders are one of compressive members, hooks, clasps, magnets, Velcro and adhesives.

6. The device according to claim 1, wherein the mounting arrangement includes a switch moving between a depressed state and a non-depressed state, the switch being in the depressed state when the stylus is received in the mounting arrangement and in the non-depressed state when the stylus is removed from the mounting arrangement.

7. The device according to claim 6, wherein the switch is biased to the non-depressed state.

8. The device according to claim 6, wherein the switch is one of a mechanical switch, an electrical contact and an optical sensor.

9. The device according to claim 6, further comprising:
a processor receiving a first signal from the switch when the switch is in the depressed state and a second signal from the switch when the switch is in the non-depressed state.

10. The device according to claim 9, wherein the processor executes a predetermined action as a function of at least one of the first and second signals.

11. An arrangement, comprising:
a processor;
a stylus;
a mounting arrangement detachably receiving the stylus; and
a switch providing data to the processor indicative of whether the stylus is received in the mounting arrangement.

12. The arrangement according to claim 11, wherein the mounting arrangement includes first and second stylus holders positioned on opposite sides of the touch screen.

13. The arrangement according to claim 12, wherein the first and second stylus holders are one of compressive members, hooks, clasps, magnets, Velcro and adhesives.

14. The arrangement according to claim 11, wherein the switch is in a depressed state when the stylus is received in the mounting arrangement and in a non-depressed state when the stylus is removed from the mounting arrangement.

15. The arrangement according to claim 14, wherein the data includes a first signal from the switch when the switch is in the depressed state and a second signal from the switch when the switch is in the non-depressed state.

16. The arrangement according to claim 14, wherein the switch is biased to the non-depressed state.

17. The arrangement according to claim 11, wherein the switch is one of a mechanical switch, an electrical contact and an optical sensor.

18. A method, comprising:
detecting a presence of a stylus in a mounting arrangement by an input/output (I/O) device, the I/O device including a touch screen having an input receiving area, the mounting arrangement receiving the stylus so that when the stylus is received in the mounting arrangement, the stylus at least partially covers the input receiving area of the touch screen;
displaying a prompt for input to the input receiving area; and
upon receiving the input in the input receiving area, displaying a prompt for the stylus to be returned to the mounting arrangement.

19. The method according to claim 18, further comprising:
upon detecting the return of the stylus in the mounting arrangement, generating a predetermined signal indicating that a transaction is complete.

20. The method according to claim 19, wherein the input receiving area is a signature line.

21. The method according to claim 20, wherein the predetermined signal is indicative of a capture of a signature traced on the signature line.

22. A device, comprising:
a display means having an input receiving area;
an input means; and
a mounting means for receiving the input means,
wherein, when the input means is received in the mounting means, the input means at least partially covers the input receiving area of the display means.
